(19) United States
(12) Patent Application Publication
(10) Pub. No.: US 2018/0153143 A1
(43) Pub. Date: Jun. 7, 2018

(54) APPARATUS, SYSTEM, AND METHOD FOR STREAM RESTORATION

(71) Applicant: James Patrick Barber, Buford, GA (US)

(72) Inventor: James Patrick Barber, Buford, GA (US)

(21) Appl. No.: 15/655,152

(22) Filed: Jul. 20, 2017

Related U.S. Application Data
(60) Provisional application No. 62/364,395, filed on Jul. 20, 2016.

(51) Int. Cl. A01K 61/70; E02B 3/04

(52) U.S. Cl. CPC A01K 61/70; E02D 2300/0067; E02D 2300/0071; E02B 3/046

(57) ABSTRACT

Systems and methods for creating habitats for benthic macro-invertebrate organisms and fish are provided. The system contains a platform and woody material attached thereto. The platform also contains openings for trapping useful organic materials, such as leaf pack and wood, and tassels that provide additional habitats or attached the woody material. The system may be installed in a river, stream, creek, or other fresh water source. The platform may be substantially flat, or may be bent to form a hollow-tube-shaped structure, with openings at both ends of the structure. The systems provide habitat, places to hold on during high flows, places to trap useable organics such as leaf pack and wood and nesting areas to support macrobenthic organisms. The system can be placed into a stream channel to restore the stream or maintain healthy conditions in a stream.

### CROSS-REFERENCE TO RELATED APPLICATION

This application claims priority to U.S. Ser. No. 62/364,395, entitled “Apparatus, System and Method for Stream Restoration”, filed Jul. 20, 2016, the disclosure of which is incorporated herein by reference.

### FIELD OF THE INVENTION

The invention is generally directed to stream restoration.

### BACKGROUND OF THE INVENTION

In many urban, newly restored or impaired streams lack the structures that are needed for benthic macroinvertebrates to live, nest, reproduce, find food, and/or hold on during high flows.

As the requirements from the regulatory agencies have become more stringent, the need for communities to have fully functioning stream systems has become more important. These communities have been spending tremendous amounts of money trying to stabilize streams and meet the needs of the regulatory agencies. Monitoring for a successful stream restoration project was originally determined based on the stabilization of the stream channel, i.e. stabilizing the physical characteristics of a stream. However, as the science of stream restoration has developed, a successful restoration project is typically requires restoration of the stream's fauna.

Since the first stream restoration project, those in the field of stream restoration worked under the premise that if you build a stable stream channel, then the aquatic fauna will return to the stream reach. This was determined to be insufficient to restore a stream's fauna. More recently, stream designers are including wood in restoration systems; however they generally include structural wood that is of little or no benefit to macrobenthics.

Stream leaf packs typically form the basic platform of cover and food substrate for many macrobenthic organisms. However, recently restored stream channels may lack adjacent vegetation, which can serve as a source of vegetative material for stream leaf packs. Thus, stream restorations often leave the native organisms without the proper substrate or supportive habitat.

There is a need for improved systems and methods for restoring streams.

Therefore it is an object of the present invention to provide improved systems and methods for restoring streams.

It is a further object of the present invention to provide a system that provides sufficient support for native organisms, such as fish and/or macro-invertebrate organisms, to live.

### SUMMARY OF THE INVENTION

Cost-effective systems and methods for creating a habitat and/or trapping food for benthic macro-invertebrate organisms and fish are provided herein. The system contains a platform and woody material, such as in the form of bundles of twigs or branches attached to the platform. The platform contains openings for trapping useful organic materials, such as leaf pack and wood, and regions for attaching the woody material to the platform.

The platform may be installed in a river, stream, creek, or other fresh water source, and then the woody material may be attached to the platform. Alternatively, the system may be assembled and then installed at the desired site in the fresh water source.

The platform may be substantially flat, or may be bent to form a hollow-tube-shaped structure, with openings at both ends of the structure. When the platform is flat, it typically is installed so that it remains attached to the bottom of the stream, i.e. anchored in place along the stream bed. When the platform is tube-shaped, it is anchored to the stream bed, the bank, or a nearby structure, such as a rock, however the rest of the system generally floats.

The systems provide habitat, places to hold on during high flows, places to trap useable organics such as leaf pack and wood and nesting areas to support macrobenthic organisms. The system can be placed into a stream channel to cultivate macrobenthic organisms in the system and thereby restore the stream or maintain healthy conditions in a stream.

### BRIEF DESCRIPTION OF THE DRAWINGS

FIGS. 1A-1D are illustrations of exemplary platforms that vary in size and distribution of windows in the platform: extra-small (1 m×6 in) (FIG. 1A), small (1 m×1.5 m) (FIG. 1B), medium (1 m×2 m) (FIG. 1C); and large (1 m×3 m) (FIG. 1D).

FIGS. 2A-2C illustrate an exemplary method of installing a stream habitat restoration system in a stream, river, or creek. FIG. 2A shows a first step of placing the platform in the desired site. FIG. 2B shows a second step of securing the platform to the site, e.g. to the bed of the stream, river, or creek.

FIG. 2C shows the attachment of bundles of wood (e.g., branches or twigs) to the platform by tying the bundles using the tassels on the platform.

FIG. 3 is an illustration of an exemplary platform rolled in the shape of a tube, which is installed in and anchored to a creek, river, or stream.

### DETAILED DESCRIPTION OF THE INVENTION

### I. Systems

A cost-effective system for creating a habitat and/or trapping food for benthic macro-invertebrate organisms and fish is provided herein. The system contains a platform which contains openings for trapping useful organic materials, such as leaf pack and wood, and regions for attaching woody material to the platform. The system also contains woody material, such as in the form of bundles of twigs or branches attached to the platform.

The platform is typically a mesh material that has the ability to hold woody bundles that can provide habitat, places to hold on during high flows, places to trap useable organics such as leaf pack and wood and nesting areas to support macrobenthic organisms. The platform allows microbenthic organisms to nest and proliferate without impeding or substantially hindering the flow of water in the stream. The system provides a stable platform that can be placed into a stream channel water column to cultivate macrobenthic organisms in the system and thereby restore the stream or maintain healthy conditions in a stream.

A. Mesh Platform

1. Materials

The mesh platform is formed from a biocompatible material that contains pores or holes, such as a woven material.

Typically, the platform is formed from a biodegradable material, that remains intact in a stream for at least one year, two years, three years, four years, five years, six years, seven years, eight years, nine years, or ten years, or longer than ten years following placement in the stream. For example, the material can degrade over a period of time ranging from 1 to 10 years after placement in a stream, such as after one year, two years, three years, four years, five years, six years, seven years, eight years, nine years, or ten years, or even longer than ten years after placement in a stream.

Suitable materials include biocompatible porous materials formed from natural or synthetic fibers, or a combination thereof. Typically, the material is a biodegradable material. Exemplary materials may be formed from coconut fibers (coir fabric), jute, hemp, bamboo, or a wood by product, or any other biodegradable, biocompatible material.

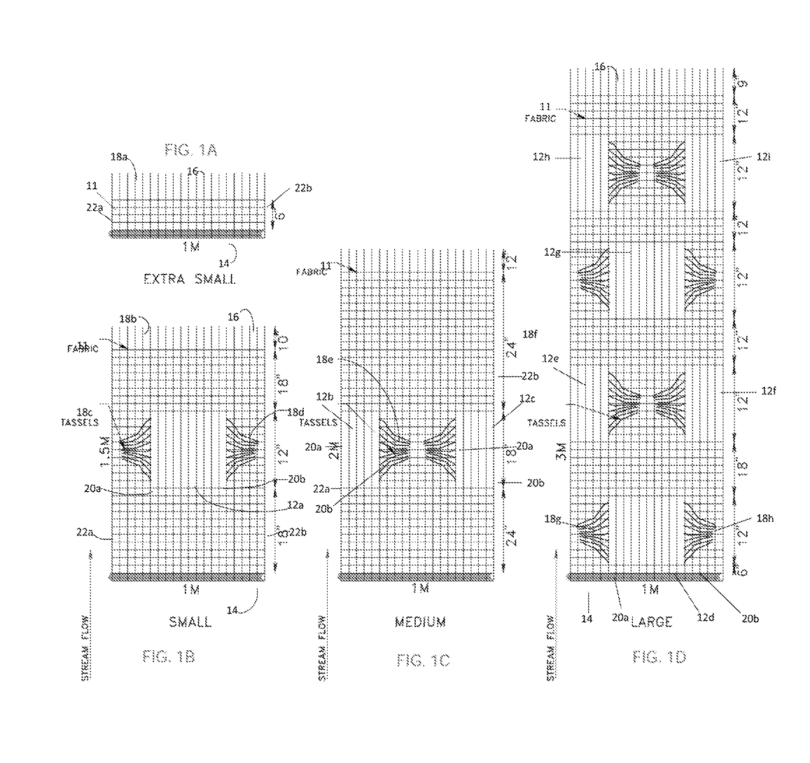

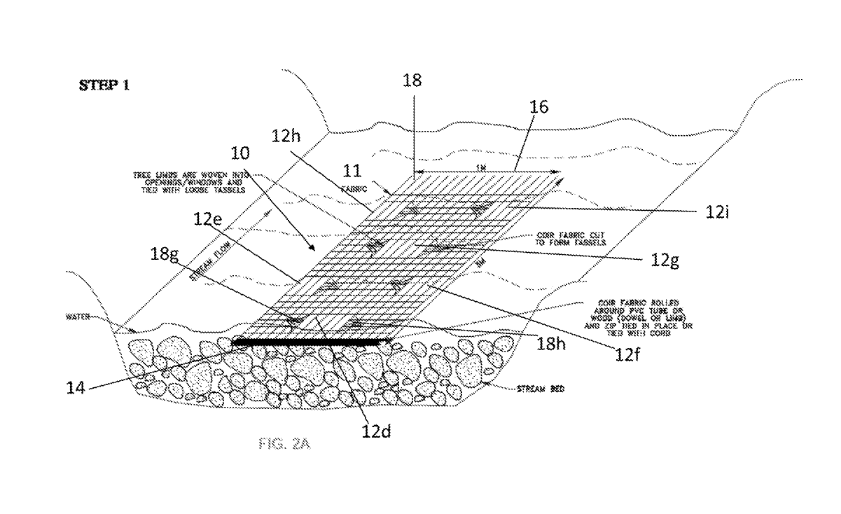

The size of the platform is selected based on the size of the area in the river, stream or creek in which the habitat will be formed. For example, the width of the platform can range from about 20 inches (about 0.5 m) to about 80 inches (about 2 m), or from about 20 inches (about 0.5 m) to about 40 inches (about 1 m), optionally the platform is about 1 m wide. The length of the platform can range from about 6 inches (about 0.15 m) to about 118 inches (about 3 m), or even longer, or any value there between. For example, the platform can have a length of about 0.15 m, 0.5 m, 1 m, 2 m, 3 m, 4 m, or even longer. Exemplary platforms have width of 1 m and a length of 6 inches, 1 m, 1.5 m, 2 m, or 3 m (see FIGS. 1A-1D).

One end of the platform is typically thicker than other end of the platform to ensure that the platform remains intact, even when subjected to the forces of a flowing stream. This end typically corresponds with the end that is installed upstream (this end is also referred to herein as the “upstream end”). The thicker, upstream end may be formed by folding over the material that forms the platform so that this end is double the thickness of the rest of the platform. Optionally, a bar, such as a tube formed from PVC or another plastic, or a wood bar or limb or branch from a tree is placed between the two levels of folded material, such that material surrounds the tube, bar, or branch and then the material is secured together via stitching, tied with cord or string or zip ties, or another suitable closure device.

In contrast the opposite end of the platform, is generally unsecured, and is installed downstream (this end is also referred to herein as the “downstream end”). The downstream end typically contains a loose fringe, formed from the individual fibers that form the material in the platform.

2. Openings

In addition to pores or small openings throughout the material that forms the platform, the material contains larger openings, also referred to herein as windows. The larger openings are typically formed by cutting one, two, three, four, five, or more consecutive cross strands, but leaving the strands that run perpendicular to the cut strands intact. The strands that are cut are typically cut at a midpoint that defines the width of the window. The cut strands form tassels on each end of the window.

The windows have a suitable size to accommodate the woody material that is woven between the remaining strands in the window. For example, the windows are typically 3 inches or greater in width and are typically 3 inches or greater in height. Suitable widths include 3 inches, 6 inches, 12 inches, and 18 inches, and the widths there between. Optionally the windows are about 12 inches to 18 inches in width. Suitable heights include 3 inches, 6 inches, 12 inches, and 18 inches, and the heights there between. Optionally the windows are about 12 inches to 18 inches in height.

In place of a single large window or a few large windows, a series of smaller windows can be located throughout the platform.

The windows are generally separated from each other by a suitable amount of intact material to maintain the structure of the platform. Suitable distances between windows or between a window and an end of the platform generally range from about 12 inches to about 24 inches, or from about 12 inches to about 18 inches. For example, the distance between adjacent windows or a window and an end of the platform can be 0 inches, 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, or greater.

3. Anchors

The platform or a portion of the platform is typically submerged beneath the surface of the stream. In some embodiments, the upstream end of the platform is anchored to the bed of the stream to fix the platform in place.

Suitable materials for anchoring the platform include rocks, rebar, duck bill anchors, screw anchors, large nut anchors, zip ties, chords, etc. Other suitable anchors are described in International Publication No. WO 2014/210100 to Barber, such as (i) hooks, chocks, wedges, or the like attached to the platform or a portion thereof by a line and held in place by a stable structure in a waterway such as a rock, (ii) spikes, posts, or rebar structures that pass through the platform or a portion thereof (or a line operably attached to the platform or a portion thereof) and driven into the bottom of a waterway, (iii) a structure similar to a marine anchor that is adapted to burrow into the bottom of a waterway and is operably attached to the platform or a portion thereof, (iv) a large and/or heavy structure such as a large rock or other item of sufficient weight and size to resist forces generated by ordinary flows in a waterway and operably attached to the platform or a portion thereof, (v) an apparatus designed to be buried in the bottom of the waterway and operably attached to the platform or a portion thereof to be secured, and (vi) other types of anchors known and understood by those of ordinary skill in the art.

B. Woody Material

Unprocessed woody material, such as in the form or twigs, branches, clippings and/or portions of a log, typically from trees that are native to the area in which the stream, brook, or creek is located, is attached to the platform. One or more, typically a plurality, of twigs or branches are grouped together forming a bundle and attached to the platform. Typically at least a portion of the bundles, or all of the bundles, are tied to the platform using the tassels located at the sides of the windows. The size of the pieces of wood in the bundles can vary; however, generally the diameter of a piece of wood is up to 5 inches, up to 4 inches, up to 3 inches, up to 2 inches, or up to 1 inch, or smaller. In preferred embodiments, the diameter of the woody material is generally 3 inches or smaller.

Optionally, woody material is also attached to the downstream end of the platform, such as by tying the fibers in the fringe around pieces of woody material.

C. Shape of the Platform

1. Flat

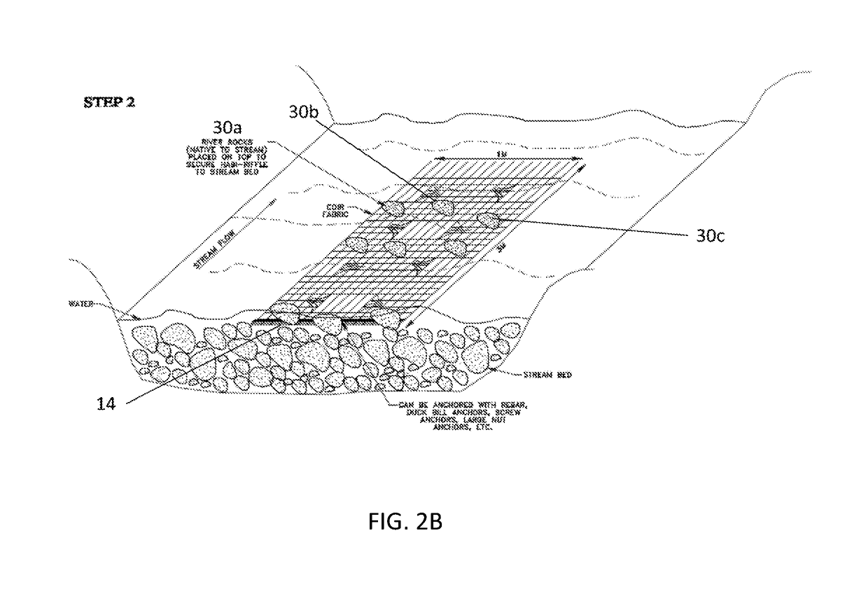

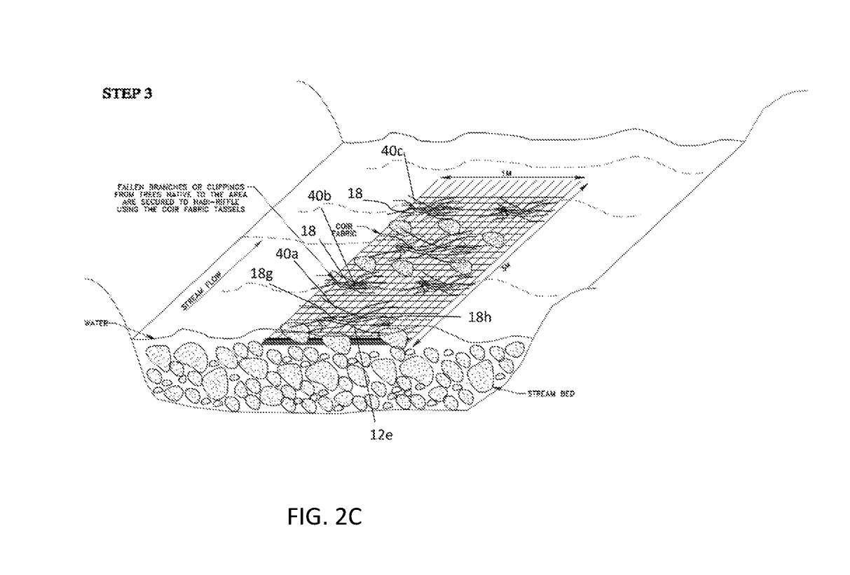

As shown in FIGS. 1A-1D and 2A-2C, the platforms in the systems can be substantially flat. In these embodiments, the platform is typically installed so that it is attached to the stream bed and the water in the stream generally flows over it.

2. Tube-Shaped

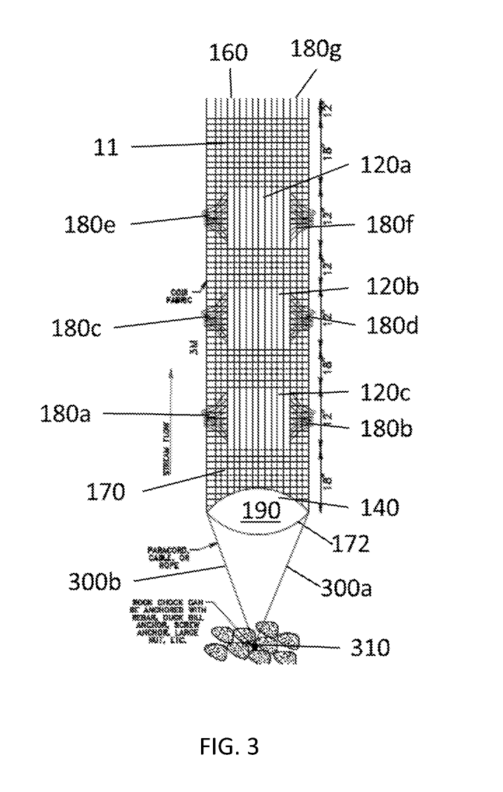

As shown in FIG. 3, in some embodiments, the platforms described above, can be bent and the sides can be attached to each other to form a tube that is open at both ends.

In these embodiments, the platforms are formed from a lightweight material that floats in the water, such as bamboo, or have one or more floatation devices attached to the platform so that it floats when it is installed in a river, stream, or creak. The upstream end of the tube-shaped platform is typically configured to be anchored to the bed of the river, stream or creek, or to the bank or a near by support structure, such as a rock or boulder.

D. Optional Features

Optionally, one or more additional structures for promoting macrobiotic growth are attached to the platform. Exemplary structures that can be attached to the platform include the bags described in International Publication No. WO 2014/210100 to Barber, the disclosure of which is incorporated herein. The bags disclosed in WO 2014/210100 contain biomass, such as leaves or wood, inside the bag and are generally closed at one end. One or more of these bags containing biomass can be attached to the platform using a suitable anchor, optionally a tie or zip-tie.

Optionally, additional pieces of material or additional tassels are added to the platform. The additional tassels can be added to any portion of the platform, such as the upstream end, the downstream end, the material on the top side of the platform, or even the material on the bottom side of the platform, which faces the bed of the waterway (e.g. for the tube-shaped platform). The tassels or the additional pieces of material imitate roots fibers and provide additional habitat for microbenthic organisms and fish.

The additional tassels can be formed from the same or a different material that forms the platform. Preferably, the tassels are formed from a biodegradable material, which is optionally a natural material, such as the materials that can be used to form the platform. The tassels contain a plurality of strands, such as in the form of mop heads from a larger material, such as the materials that can be used to form the platform.

### II. Methods of Use

The systems described herein can be placed in a waterway, such as a stream, creek, or river or other fresh water source, as part of a waterway restoration program. The systems can be used to recreate woody riffles and debris bundles in the streams, and thereby create habitats and trap food for macrobenthic organisms and/or fish.

The systems described herein can provide habitats for one or more types of macrobenthic organisms, such as aquatic worms, left-handed snails, rat-tailed maggots, blood midge larvae, midge larvae, planaria, black fly larvae, leeches, damselfly nymphs, dragonfly nymphs, scud, crayfish, sowbugs, cranefly, clams, mussels, stonefly nymphs, mayfly nymphs, riffle beetles (adults and larvae), caddisfly larvae, dobsonfly larvae, water penny larvae, and right-handed snails.

A. Assembly and Installation of System

Prior to installation in a river or stream, a platform having the appropriate dimensions for placement in the stream or river is selected. The system is typically installed in riffles or glides in a stream, as these are locations where macrobenthic organisms typically live. However, for embodiments in which the platform is designed to float in the stream, e.g. when the platform is tube-shaped, the system can be placed anywhere in the stream that it is able to anchor to the bank, or a portion of the stream bed.

An exemplary installation method is illustrated in FIGS. 2A-2D. Optionally, the platform is placed in the desired site of the stream and is fixed in place, such as by attaching one portion, typically the upstream end, of the platform to the stream bed, creek bed or river bed or to a rock or bolder therein. The platform may be fixed by any suitable means, typically by anchoring the upstream end 14 of the platform 10 to the stream, creek, or river bed (See, e.g., FIG. 2B).

Alternatively, or additionally, one or more rocks 30a, 30b, 30c or boulders are placed in different locations on top of the platform, further securing the platform in place (See, e.g., FIG. 2B). Once secured in place, one or more woody bundles 40a, 40b, 40c are attached to the platform by any suitable means, such as by tying them with or to the tassels, using zip ties, or attaching them using string or rope. (See, e.g., FIG. 2C) Typically, the woody bundles are attached to the platform, adjacent to a window, by tying a set of the tassels 18 around each bundle.

In an alternative method for installing the system at a site in a river, stream, or creek, prior to installing the platform in the site, one or more woody bundles are attached to the platform by any suitable means, such as by weaving or intertwining the wood through the holes in the material or the open portions of the windows, tying them with or to the tassels, using zip ties, or attaching them using string or rope. In this embodiment, after the system is assembled, it is installed in the desired site in the river, creek or stream and secured by anchoring the upstream side to the bed of the river, creek or stream, and optionally by anchoring other portions of the platform to the bed of the river, creek or stream or placing one or more rocks at different locations on top of the platform (see, e.g., FIG. 2C)

Following the above-described installation methods, the system is typically located beneath the surface of the water in the stream, creek or river with the platform generally sitting on the bottom of the bed and the woody bundles extend upward from the platform and into the water column. As the system remains in place in the channel of the river, stream, or creek, leaf packs can gather in and on the platform or the woody bundles as the water flows downstream. Additionally, as macrobenthic organisms and/or fish flow downstream, they collect or attach to the woody bundles in the system, and/or to the leaf packs that attach to the system. The macrobenthic organisms and/or fish secure their new habitat in a woody riffle.

Within days following installation, macrobenthic organisms and/or fish begin attaching to the system and establishing new habitats. Within 30 days following installation, new habitats for macrobenthic organisms and/or fish are fully established.

B. Floating Platform

In an alternative embodiment, the platform can be bent and the sides attached to each other to form a hollow tube, which is able to float in the stream, creek, or river. In these embodiments a material that floats is typically used inside or attached along the sides of the platform. Preferred materials are bamboo and cedar because they are biodegradable. However, any material that floats can be used.

Alternatively, the platform can be formed from any of the materials described above, and the platform can be attached to one or more flotation devices to cause the platform to float. Then the platform is attached to the bank, stream bed or rocks to prevent it from floating away.

In this embodiment, preferably the woody bundles that are attached to the platform extend out laterally and downwardly from the platform into the water column.

Optionally, the bottom side (i.e. the side facing the bed of the river, stream or creek) of this platform contains additional tassels that are able to simulate roots. This structure can provide additional habitats for small fish and benthic macroinvertebrates.

### III. Examples

A. Flat Platforms

Exemplary platforms 10 are illustrated in FIGS. 1A-1D. The platform is formed from a mesh or woven material 11 and contains one or more tassels for attaching woody material to the platform. In most embodiments, the platform also contains one or more windows 12a, 12b, 12c (collectively 12). Optionally, for very small platforms, such as depicted in FIG. 1A, the platform does not contain a window, but does contain tassels at least at the downstream end of the platform.

Typically the platform is installed in the channel of a waterway, such as river, creek, or stream or other fresh water source, with a first, upstream end 14 anchored to the stream bed using a suitable anchoring device. As shown in FIGS. 1A-1D, the platform is aligned with the direction of the flow of the river, creek or stream such that the second, downstream end 16 is located downstream of the first, upstream end 14.

Each window contains at least one set of tassels 18a, 18b, 18c (collectively 18) on one side of the window 12. For a window 12 where both sides 20a, 20b of the window are adjacent to the material 11 that forms that platform, then each of the sides of the window contain a set of tassels (see, e.g. window 12b in FIG. 1B). For a window where one side of the window corresponds with a side of the platform 22a or 22b, then only the opposite side of the window contains a set of tassels.

Woody material, optionally in the form of a bundle, may be woven through the small openings in the material and or the windows and attached to one more of the sets of tassels to form the system. Optionally, some of the tassels are not attached to woody material, allowing the tassels to imitate roots fibers and provide additional habitat for microbenthic organisms and fish.

B. Floating, Tube-Shaped Platform

An exemplary tube-shaped platform 100 is illustrated in FIG. 3. The platform is formed from a mesh or woven material 11 which contains one or more windows 120a, 120b, 120c (collectively 120). Typically the platform is installed in the channel of a river, creek, or stream with a first, upstream end 140 anchored to the stream bed using a suitable anchoring device 310. The upstream end 140 may contain one or more cords, cables, ropes, or other suitable materials 300 for attaching it to the stream bed.

The platform contains a first, top side 170 and a second, bottom side 172 (the surface of the bottom side is generally not visible in the figures). The first, top side is visible in FIG. 3. As shown in FIG. 3, the platform is aligned such that the second, downstream end 160 is located downstream of the first, upstream end 140. The tube-shape platform is hollow inside and open 190 at both the upstream end 140 and the downstream end 160.

Each window contains at least one set of tassels 180a, 180b, 180c (collectively 180) on one side of the window 120. Generally, as shown in FIG. 3, the windows 120 are adjacent to the material 11 that forms that platform, and contain a set of tassels on both sides of each of the windows.

When the woody material is attached to the platform and the system is installed in a river, creek, or stream, the woody bundles generally extend out away from the platform into the water column.

Woody material, optionally in the form of a bundle, may be woven through the small openings in the material and or the windows and attached to one more of the sets of tassels to form the system. Optionally, some of the tassels are not attached to woody material, allowing the tassels to imitate roots fibers and provide additional habitat for microbenthic organisms and fish.

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

I claim:

1. A platform for use in a waterway restoration system, comprising a mesh material comprising one or more openings, where at least one side of each opening comprises loose fibers in the form of tassels.

2. The platform of claim 1, wherein the material is a natural, biodegradable material, preferably selected from the group consisting of coir fabrics, jute, hemp, and bamboo.

3. The platform of claim 1, wherein the platform is flat or in the shape of a hollow tube.

4. The platform of claim 1, comprising two or more openings, where the openings are separated from each other by at least 6 inches of material.

5. The platform of claim 1, wherein the platform comprises a first end and a second end, wherein the first end is opposite the second end and wherein the first end is thicker than the rest of the material in the platform.

6. The platform of claim 5, wherein the second end contains loose fibers in the form of tassels.

7. The platform of claim 1, further comprising one or more bags containing biomass, such as leaf pack, therein attached to the platform.

8. A system for restoring a waterway, comprising
a platform, comprising a mesh material comprising one or more openings, where at least one side of each opening comprises loose fibers in the form of tassels, wherein woody material is attached to the platform.

9. The system of claim 8, wherein the woody material comprises branches, twigs, portions of a log, or a combination thereof.

10. The system of claim 8, wherein the woody material is gathered into bunches.

11. The system of claim 8, wherein the woody material is attached to the platform by tying the tassels around the woody material.

12. The system of claim 8, wherein the woody material is woven between fibers in the mesh material.

13. The system of claim 8, wherein a portion of the tassels are not attached to woody material, and wherein the portion of the tassels are configured to mimic root material when the system is installed in a waterway.

14. A method for restoring a waterway comprising installing a platform, comprising a mesh material comprising one or more openings, where at least one side of each opening comprises loose fibers in the form of tassels, in the waterway.

15. The method of claim 14, wherein following installation of the platform, woody material is attached to the platform forming a system.

16. The method of claim 14, wherein woody material is attached to the platform forming a system prior to installation in the waterway.

17. The method of claim 14, wherein the platform is installed by attaching one end of the platform to the bed of the waterway via an anchor.

18. The method of claim 14, wherein the waterway is selected from the group consisting of creeks, rivers, streams, and other freshwater sources.

19. The method claim 14, wherein 1 to 10 days following installation, one or more benthic macro-invertebrate organisms, fish, or a combination thereof are living in the system.

20. The method of claim 14, wherein within one month following installation, one or more habitats for benthic macro-invertebrate organisms, fish, or a combination thereof are located in or one the system.
